(19) United States
(12) Patent Application Publication
(10) Pub. No.: US 2006/0099530 A1
(43) Pub. Date: May 11, 2006

(54) Polymerized toner and method for preparing the same

(76) Inventors: Woong-ki Lee, Daejeon (KR); Chang-soon Lee, Daejeon (KR); Tae-hee Yoon, Daejeon (KR); Woo-cheul Jeong, Ulsan (KR)

Correspondence Address: MCKENNA LONG & ALDRIDGE LLP, 1900 K STREET, NW, WASHINGTON, DC, 20006, US

(21) Appl. No.: 11/268,733

(22) Filed: Nov. 8, 2005

(30) Foreign Application Priority Data
Nov. 8, 2004 (KR) 10-2004-0090369

(51) Int. Cl. G03G 9/08

(52) U.S. Cl. 430/137.15; 430/105; 430/109.3

(57) ABSTRACT

The present invention relates to a polymerized toner prepared by suspension polymerization. Provided is a method for preparing a toner comprising the steps of (1) preparing a toner by suspension polymerization using a water-based dispersant that adjusts size of emulsion particles, which are formed as byproduct, to 0.05-2 μm; and (2) removing the dispersant from the toner surface, refining the toner, so that concentration of the emulsion particles becomes 0.01-2 wt % of the toner, and filtering and drying the toner in vacuum. Also provided is a toner prepared by suspension polymerization using a water-based dispersant, concentration of emulsion particles being 0.01-2% and diameter of the emulsion particles being 0.05-2 μm. The present invention provides a good toner having fusing property and developing property by effectively controlling the concentration of emulsion particles formed during suspension polymerization as byproduct.

### TECHNICAL FIELD

The present invention relates to a toner having superior fusing property and developing property and a method for preparing the same, more particularly to a polymerized toner having improved developing property and fusing property by mechanically removing emulsion particles formed when preparing the polymerized toner by suspension polymerization to optimize concentration of the emulsion particles in the toner and a method for preparing the same.

### BACKGROUND ART

In general, a toner refers to an ink used in electrophotographic development, electrostatic printing, copying, etc. to develop transcribed images. Recently, with the generalization of computer-aided documentation and the subsequent rapid increase in demand of imaging apparatuses such as printer, use of toner is also on the increase.

The toners are prepared by several methods.

In the melting-mixing process, the most widely known toner preparation method, a resin and a pigment are molten and mixed or extruded, and the resultant mixture is crushed and classified by size to obtain toner particles. However, since such prepared toner particles have a broad particle diameter distribution and very irregular shapes, e.g. sharp edges, they tend to have bad charge property or flow property.

To solve this problem, methods for preparing spherical toner particles by polymerization were proposed. Emulsion polymerization and suspension polymerization are known as such toner preparation methods. Since emulsion polymerization is complicated and thus has the problem of reproducibility of toner quality, suspension polymerization is preferred.

U.S. Pat. No. 5,605,992 discloses a method for preparing a toner by suspension polymerization. When preparing a toner by suspension polymerization, emulsion particles are formed in general because of solubility of the initiator and the polymerization monomer to water, which is used as dispersion medium. The emulsion particles reduce stability of the suspension polymerization and, if not completely removed from the final product, adsorb the toner particles, thereby aggravating developing property and fusing property of the toner.

U.S. Pat. No. 5,605,992 asserts that formation of the emulsion particles can be minimized by using a water-soluble polymerization inhibitor. But, it is impossible to completely prevent formation of the emulsion particles and the water-soluble polymerization inhibitor may affect the suspension polymerization or may remain in the final toner particles, thereby negatively affecting properties of the toner.

Thus, a method for mechanically removing the emulsion particles from a toner, so that developing property of the toner is not impaired, is required.

### DISCLOSURE OF INVENTION

The present inventors found out that when emulsion particles formed during suspension polymerization, which reduce property and fusing property of a toner, are removed below a certain concentration, interruption of charging by the excessive emulsion particles can be prevented, and thus uniform charging can be attainted.

It is an object of the present invention to provide a toner having good fusing property and superior developing property by controlling concentration of emulsion particles, which are formed as byproduct during suspension polymerization.

To attain the object, the invention provides a method for preparing a toner comprising the steps of (1) preparing a toner by suspension polymerization using a water-based dispersant that adjusts the size of emulsion particles, which are formed as byproduct, to 0.05-2 μm; and (2) removing the dispersant from the surface of the toner, refining the toner, so that concentration of the emulsion particles becomes 0.01-2 wt % of the toner, and filtering and drying the toner in vacuum.

The invention also provides a toner prepared by suspension polymerization using a water-based dispersant, which is characterized by having emulsion particle concentration in the toner of 0.01-2% and emulsion particle diameter of 0.05-2 μm.

Hereunder is given a more detailed description of the invention.

The toner provided by the invention is described by the following suspension polymerization process.

(1) Preparation of Polymerized Toner

A water-based dispersion is prepared using 0.1-20 parts by weight, per 100 parts by weight of the total monomers, of a water-based dispersant selected from a group consisting of a water-based inorganic dispersant, a water-soluble organic polymer dispersant and an anionic surfactant.

For the monomer, an aromatic vinyl monomer, an acrylate monomer, a methacrylate monomer, a diene monomer or a mixture thereof can be used. Optionally, an acid or basic olefin monomer may be used.

1-60 parts by weight, per 100 parts by weight of a water-based dispersion, of a monomer mixture comprising 30-95 parts by weight, per 100 parts by weight of the total monomers, of an aromatic vinyl monomer; 5-70 parts by weight, per 100 parts by weight of the total monomers, of at least one monomer selected from a group consisting of an acrylate monomer, a methacrylate monomer and a diene monomer; optionally 0.1-30 parts by weight, per 100 parts by weight of the total monomers, of an acidic or basic olefin monomer; 1-20 parts by weight, per 100 parts by weight of the total monomers, of a pigment; 0.1-30 parts by weight, per 100 parts by weight of the total monomers, of a wax; 0.001-10 parts by weight, per 100 parts by weight of the total monomers, of a cross-linking agent; 0.1-20 parts by weight, per 100 parts by weight of the total monomers, of a charge control agent; 0.001-8 parts by weight, per 100 parts by weight of the total monomers, of a chain transfer agent to control the molecular weight; and 0.01-5 parts by weight, per 100 parts by weight of the total monomers, of a polymerization initiator is mixed with 100 parts by weight of a water-based dispersion.

Polymerization is performed while applying shear force to the resultant mixture using a homogenizer to prepare a toner core.

Optionally, 0.01-10 parts by weight of at least one polar polymer selected from a group consisting of polyester and styrene-acrylate can be added to the monomer.

For the aromatic vinyl monomer, styrene, monochlorostyrene, methylstyrene, dimethylstyrene, etc. can be used. Preferably, the aromatic vinyl monomer is comprised in 30-95 parts by weight per 100 parts by weight of the total monomers.

For the acrylate monomer, methyl acrylate, ethyl acrylate, n-butyl acrylate, isobutyl acrylate, dodecyl acrylate, 2-ethylhexyl acrylate, etc. may be used. For the methacrylate monomer, methyl methacrylate, ethyl methacrylate, n-butyl methacrylate, isobutyl methacrylate, dodecyl methacrylate, 2-ethylhexyl methacrylate, etc. may be used. And, for the diene monomer, butadiene, isoprene, etc. may be used.

Preferably, at least one of the acrylate monomer, methacrylate monomer and diene monomer is comprised in 5-70 parts by weight of per 100 parts by weight of the total monomers.

For the acidic olefin monomer, a compound having a carboxyl group such as α,β-ethylene may be used. And, for the basic olefin monomer, a compound having an amine group or a quaternary ammonium group, such as methacrylic acid ester, methacrylamide, vinylamine or diallylamine of an aliphatic alcohol or ammonium salts thereof, may be used.

Preferably, the acidic or basic olefin monomer is comprised in 0.1-30 parts by weight per 100 parts by weight of the total monomers.

For the wax, at least one selected from a group consisting of a natural wax such as a petroleum-refined wax like paraffin wax, microcrystalline wax, ceresin wax; and carnauba wax; or a synthetic wax such as ester wax, polyethylene wax and polypropylene wax may be used.

Preferably, the wax is comprised in 0.1-30 parts by weight per 100 parts by weight of the total monomers.

For the reaction initiator, an oil-soluble initiator or a water-soluble initiator may be used. Specifically, an azo initiator like azobisisobutyronitrile, azobisvaleronitrile, etc.; an organic peroxide like benzoyl peroxide, lauroyl peroxide, etc.; or a commonly used water-soluble initiator like potassium persulfate, ammonium persulfate, etc. may be used.

Preferably, the reaction initiator is comprised in 0.01-5.00 parts by weight, more preferably in 0.1-2.0 parts by weight, per 100 parts by weight of the total monomers.

For the change control agent, at least one mercaptan compound such as t-dodecylmercaptan, n-dodecylmercaptan, etc. may be used. Preferably, the molecular weight controller is comprised in 0.001-8.000 parts by weight per 100 parts by weight of the total monomers.

For the pigment, an inorganic pigment such as metal powder, metal oxide, carbon black, sulfide, chromate and ferrocyanide, an organic pigment such azo dye, acidic dye, basic dye, mordant dye, phthalocyanine, quinacridone and dioxin or a mixture thereof may be used. The pigment is comprised in 1-20 parts by weight per 100 parts by weight of the total monomers.

For the charge control agent, a cationic charge controller such as a nigrosine type electron acceptor dye, a high aliphatic metal salt, an alkoxyamine, a chelate, a quaternary ammonium salt, an alkylamide, a fluorine-treated activator and a naphthalenic acid metal salt, an anionic charge controller such as an electron acceptor organic complex, chlorinated paraffin, chlorinated polyester, polyester containing excessive acid, sulfonylamine of copper phthalocyanine and styrene-acryl polymer having sulfonate group or a mixture thereof may be used. Preferably, the charge control agent is comprised in 0.1-20 parts by weight per 100 parts by weight of the total monomers.

For the cross-linking agent, divinylbenzene, ethylene dimethacrylate, ethylene glycol dimethacrylate, diethylene glycol diacrylate, 1,6-hexamethylene diacrylate, allyl methacrylate, 1,1,1-trimethylolpropane triacrylate, triallylamine, tetraallyloxyethane, etc. may be used. Preferably, the cross-linking agent is comprised in 0.001-10 parts by weight per 100 parts by weight of the total monomers.

For the water-based dispersant, at least one selected from a group consisting of an inorganic dispersant, a water-soluble organic polymer dispersant and an anionic surfactant is used. Preferably, the water-based dispersant is comprised in 0.1-20 parts by weight per 100 parts by weight of the total monomers.

For the inorganic dispersant, an insoluble calcium salt, an insoluble magnesium salt, a hydrophilic silica, a hydrophobic silica, a colloidal silica, etc. may be used.

For the water-soluble organic polymer dispersant, a non-ionic polymer dispersant such as polyoxyethylene alkyl ether, polyoxyalkylene alkyl phenol ether, sorbitan fatty acid ester, polyoxyalkylene fatty acid ester, glycerine fatty acid ester, polyvinyl alcohol, alkyl cellulose and polyvinyl pyrrolidone or an ionic polymer dispersant such as polyacrylamide, polyvinylamine, polyvinylamine N-oxide, polyvinyl ammonium salt, polydialkyldiallyl ammonium salt, polyacrylic acid, polystyrenesulfonic acid, polyacrylate, polystyrene sulfonate and polyaminoalkyl acrylate may be used.

For the anionic surfactant, a fatty acid salt, an alkyl sulfate ester salt, an alkyl aryl sulfate ester salt, a dialkyl sulfosuccinate, an alkyl phosphate, etc. may be used.

Preferably, the emulsion particles formed during preparation of the toner as byproduct have a particle diameter of 0.05-2 μm. If the particle diameter is smaller than 0.05 μm, the emulsion particles are not readily removed from the toner surface because of their high adsorbing property, thereby reducing developing property. Otherwise, if it exceeds 2 μm, reduction of fusing property and contamination of images may occur.

Particle diameter of the emulsion particles may be controlled through the concentration of the water-based dispersant. To control the emulsion particle diameter to 0.05-2 μm, the water-based dispersant is preferably comprised in 0.1-20 parts by weight per 100 parts by weight of the total monomers. If the content of the water-based dispersant is smaller than 0.1 part by weight, the reaction system may become unstable. Otherwise, if it exceeds 20 parts by weight, excessive emulsion particles are formed, thereby making uniform toner polymerization impossible.

(2) Removal of Emulsion Particles

From the solution containing the prepared polymerized toner, the dispersant is removed from the toner with a suitable method. In case colloidal silica is used as the water-based dispersant, an aqueous NaOH solution having a concentration of 0.05-0.2 N may be added to remove the silica from the toner surface.

Next, the solution is refined, so that the concentration the emulsion particles becomes 0.01-2% of the toner. The toner is separated and dried at room temperature in a vacuum oven for 48 hours to obtain the final toner particles. If the concentration of the emulsion particles is below 0.01%, drum filming is observed. Otherwise, if it exceeds 2%, developing property and fusing property are reduced.

The dispersant and the emulsion particles may be separated from the toner by separation and refinement using such apparatuses as filter, filter press, centrifuge and continuous decanter type high-speed centrifuge. Times of centrifuging, centrifugal force, times of refinement, materials used for refinement, etc. can be adjusted to control the concentration of the emulsion particles. Also, classification of fine toner particles may be anticipated.

### BEST MODE FOR CARRYING OUT THE INVENTION

The present invention is described further in detail through examples. However, the following examples are only for the understanding of the invention and the invention is not limited to or by them.

### EXAMPLE 1

(Preparation of Polymerized Toner)

10 g of colloidal silica, a dispersant, was dissolved in 400 g of distilled water in a 500 mL reactor. The reactor was heated to the reaction temperature of 70° C. to prepare a water-based dispersion.

160 g of styrene, 36 g of n-butyl acrylate and 4 g of acrylic acid were used as monomer. 4 g of allyl methacrylate, a cross-linking agent, and 0.02 g of n-dodecylmercaptan, a chain transfer agent, were added to the monomer. Then, 1 g of a styrene-acryl polymer charge control agent having a sulfonate group was sufficiently dissolved and 10 g of carbon black was added. The mixture was stirred with a bead mill at 2000 rpm for 2 hours. Then, beads were removed to obtain 105 g of a monomer/pigment mixture.

The mixture was heated to 70° C. using a water bath. Then, 5 g of paraffin wax was added and dissolved sufficiently for 20 minutes while stirring. To the resultant monomer mixture was added 2 g of azobisisobutyronitrile as polymerization initiator. Then, stirring was performed for 5 minutes.

The reaction mixture was added to the water-based dispersion prepared above. Reaction was continued for 20 minutes while stirring at 10,000 rpm using a homogenizer. Then, reaction was performed for 15 hours stirring at 600 rpm using a common stirrer to obtain a polymerized toner.

(Refinement by Centrifuge)

To the prepared toner was added an aqueous NaOH solution. Silica was removed from the toner surface, while adjusting the NaOH concentration to 0.1 N.

The reaction mixture from which the silica had been removed was centrifuged, decantered and re-dispersed using a centrifuge (Beckman J2-21M, Rotor JA-14) at 3,000 rpm for 15 minutes with distilled water. The process was repeated 10 times to remove the silica and emulsion particles, so that the emulsion particle concentration became 0.4% of the toner. At last, moisture was removed by filtering and the resultant toner cake was dried at room temperature in a vacuum oven for 48 hours to obtain a toner.

Size and shape of the obtained toner particles were measured and observed using a Multisizer Coulter counter and SEM. Average particle diameter of the toner was 7.2 μm and average emulsion particle was 0.2 μm.

2 parts by weight of surface-treated silica RY200S (Degussa, Germany) was added to the prepared toner. After mixing for surface treatment at 4,000 rpm for 3 minutes using a blender, printing test was performed using an HP 4600 printer (Hewlett-Packard). Image density (ID) was measured with Macbeth, Model No. RD918. The result is shown in Table 1 below.

### EXAMPLES 2-9

Concentration of colloidal silica was adjusted as specified in Table 1 to control emulsion particle diameter. Number of centrifuge runs was adjusted to control emulsion particle concentration.

2 parts by weight of surface-treated silica RY200S was added to the prepared toner. After mixing for surface treatment at 4,000 rpm for 3 minutes using a blender, printing test was performed using an HP 4600 printer (Hewlett-Packard). Image density (ID) was measured with Macbeth, Model No. RD918. The result is shown in Table 1.

### COMPARATIVE EXAMPLE 1

A toner was prepared in the same manner of Example 1. To the prepared toner was added an aqueous NaOH solution. Silica was removed from the toner surface, while adjusting the NaOH concentration to 0.1 N.

The reaction mixture from which the silica had been removed was centrifuged, decantered and re-dispersed using a centrifuge (Beckman J2-21M, Rotor JA-14) at 3,000 rpm for 15 minutes with distilled water. The process was repeated 10 times. The toner was dispersed again in distilled water and shear force was applied for 10 minutes using a homogenizer. Then, centrifuging, decantering and re-dispersing were performed for 10 times, so that the emulsion particle concentration became 0.008% of the toner. At last, moisture was removed by filtering and the resultant toner cake was dried at room temperature in vacuum for 48 hours to obtain a toner.

Size and shape of the obtained toner particles were measured and observed using a Multisizer Coulter counter and SEM.

2 parts by weight of surface-treated silica RY200S was added to the prepared toner. After mixing for surface treatment at 4,000 rpm for 3 minutes using a blender, printing test was performed using an HP 4600 printer (Hewlett-Packard). Image density (ID) was measured with Macbeth, Model No. RD918. The result is shown in Table 1.

### COMPARATIVE EXAMPLE 2

(Refinement by Simple Filtering)

A toner was prepared in the same manner of Example 1. Refinement and filtering with water were repeated for 3 times to mainly remove the dispersant. The emulsion particle was adjusted to 2.5% and the resultant toner cake was dried in a vacuum oven at room temperature for 48 hours to obtain a toner.

Size and shape of the obtained toner particles were measured and observed using a Multisizer Coulter counter and SEM.

2 parts by weight of surface-treated silica RY200S was added to the prepared toner. After mixing for surface treatment at 4,000 rpm for 3 minutes using a blender, printing test was performed using an HP 4600 printer (Hewlett-Packard). Image density (ID) was measured with Macbeth, Model No. RD918. The result is shown in Table 1.

### COMPARATIVE EXAMPLE 3

(Large Emulsion Particle Size)

Only 1 g of colloidal silica was used to adjust the emulsion particle diameter to 2.2 μm, as given in Table 1. To the prepared toner was added an aqueous NaOH solution. Silica was removed from the toner surface, while adjusting the NaOH concentration to 0.1 N.

The reaction mixture from which the silica had been removed was centrifuged, decantered and re-dispersed using a centrifuge (Beckman J2-21M, Rotor JA-14) at 3,000 rpm for 15 minutes with distilled water. The process was repeated 10 times. Moisture was removed by filtering and the resultant toner cake was dried at room temperature in vacuum for 48 hours to obtain a toner.

Size and shape of the obtained toner particles were measured and observed using a Multisizer Coulter counter and SEM.

2 parts by weight of surface-treated silica RY200S was added to the prepared toner. After mixing for surface treatment at 4,000 rpm for 3 minutes using a blender, printing test was performed using an HP 4600 printer (Hewlett-Packard). Image density (ID) was measured with Macbeth, Model No. RD918. The result is shown in Table 1.

TABLE 1

| | | | Emulsion | Emulsion | | | | |
|---|---|---|---|---|---|---|---|---|
| | | | particle | particle | ID | | | |
| | Colloidal | Times of | diameter | concentration | | 200 | Fusing | |
| Sample No. | silica (g) | centrifuge | (nm) | (%) | 1 sheet | sheets | property | Remarks |
| Example 1 | 10 | 10 | 0.2 | 0.4 | 1.49 | 1.45 | Superior | |
| Example 2 | 10 | 7 | 0.2 | 1.0 | 1.47 | 1.43 | Superior | |
| Example 3 | 10 | 5 | 0.2 | 1.5 | 1.46 | 1.40 | Good | |
| Example 4 | 5 | 10 | 0.6 | 0.6 | 1.46 | 1.41 | Superior | |
| Example 5 | 5 | 7 | 0.6 | 1.2 | 1.42 | 1.36 | Good | |
| Example 6 | 5 | 5 | 0.6 | 1.8 | 1.40 | 1.32 | Good | |
| Example 7 | 3 | 10 | 1.2 | 0.8 | 1.38 | 1.32 | Good | |
| Example 8 | 3 | 7 | 1.2 | 1.5 | 1.36 | 1.29 | Good | |
| Example 9 | 3 | 5 | 1.2 | 1.8 | 1.34 | 1.25 | Good | |
| Comp. | 10 | 20 | 0.2 | 0.008 | 1.52 | 1.49 | Superior | Drum filming |
| Example 1 | | | | | | | | |
| Comp. | 10 | — | 0.2 | 2.5 | 1.30 | 1.22 | Poor | |
| Example 2 | | | | | | | | |
| Comp. | 1 | 10 | 2.2 | 1.3 | 1.25 | 1.12 | Poor | Image |
| Example 3 | | | | | | | | contamination |

As seen in Table 1, unless emulsion particles were removed effectively, reduction in image density (ID) increased or image density itself decreased as printing was repeated. Further, fusing property was not good, either.

And, when emulsion particle concentration is too low (Comparative Example 1), drum filming was observed, although developing property and fusing property were superior.

As can be seen from above result, developing property and fusing property of the toners according to the present invention (Examples 1-9) were dependent upon the degree of emulsion particle treatment.

### INDUSTRIAL APPLICABILITY

As described above, the present invention provides a good toner having fusing property and developing property by effectively controlling the concentration of emulsion particles formed during suspension polymerization as byproduct.

While the present invention has been described in detail with reference to the preferred embodiments, those skilled in the art will appreciate that various modifications and substitutions can be made thereto without departing from the spirit and scope of the invention as set forth in the appended claims.

1. A method for preparing a toner comprising the steps of
(1) preparing a toner by suspension polymerization using a water-based dispersant that adjusts the size of the emulsion particles formed as byproduct to 0.05-2 μm; and
(2) removing the dispersant from the toner, refining the toner, so that the concentration of the emulsion particles becomes 0.01-2 wt % of the tone, and filtering and drying the toner in vacuum.

2. The method of claim 1, the water-based dispersant being at least one selected from a group consisting of an inorganic dispersant selected from a group consisting of an insoluble calcium salt, an insoluble magnesium salt, hydrophilic silica, hydrophobic silica and colloidal silica; a non-ionic polymer dispersant selected from a group consisting of polyoxyethylene alkyl ether, polyoxyalkylene alkyl phenol ether, sorbitan fatty acid ester, polyoxyalkylene fatty acid ester, glycerine fatty acid ester, polyvinyl alcohol, alkyl cellulose and polyvinyl pyrrolidone; an ionic polymer dispersant selected from a group consisting of polyacrylamide, polyvinylamine, polyvinylamine N-oxide, polyvinylammonium salt, polydialkyldiallylammonium salt, polyacrylic acid, polystyrenesulfonic acid, polyacrylate, polystyrene sulfonate and polyaminoalkyl acrylate; and an anionic surfactant selected from a group consisting of a fatty acid salt, an alkyl sulfate ester salt, an alkyl aryl sulfate ester salt, a dialkyl sulfosuccinate and an alkyl phosphate.

3. The method of claim 1, the water-based dispersant being comprised in 0.1-20 parts by weight per 100 parts by weight of the total monomers.

4. The method of claim 1, wherein colloidal silica is used as water-based dispersant to prepare a polymerized toner and a 0.05-0.2 N aqueous NaOH solution is added to remove the colloidal silica from the toner surface.

5. The method of claim 1, wherein concentration of the emulsion particles is adjusted to 0.01-2% of the toner by repeating centrifuge, decantering and re-distribution using a centrifuge.

6. A toner prepared by suspension polymerization using a water-based dispersant, concentration of emulsion particles being 0.01-2% and diameter of the emulsion particles being 0.05-2 μm.
